(19) United States
(12) Patent Application Publication
(10) Pub. No.: US 2026/0148246 A1
(43) Pub. Date: May 28, 2026

(54) LINEAGE BASED APPROACH TO MEASURE CARBON FOOTPRINT IN DISTRIBUTED WORKFLOWS

(71) Applicant: HEWLETT PACKARD ENTERPRISE DEVELOPMENT LP, Spring, TX (US)

(72) Inventors: Annmary Justine Koomthanam, Fot Collins, CO (US); Arun Mahendran, Bangalore (IN); Suparna Bhattacharya, Bangalore (IN)

(21) Appl. No.: 19/047,809

(22) Filed: Feb. 7, 2025

(30) Foreign Application Priority Data
Nov. 22, 2024 (IN) 202441090989

(51) Int. Cl. G06Q 30/018

(52) U.S. Cl. CPC G06Q 30/018

(57) ABSTRACT

Systems and methods are provided to track and calculate the carbon generated by individual processing stages of a processing pipeline or an individual artifact. The system may track and store the lineage/dependencies of the data from individual applications that are involved in the processing pipeline. The applications may transmit their metadata to the system to record the metadata associated with the execution. The system can track the carbon footprint from start to finish of individual stages at the job/pipeline level or each of the processing steps of generating the individual artifact.

### BACKGROUND

Reducing the carbon footprint of computer processing tasks has become one of the top goals for most leading companies. The motivation for reducing the carbon footprint includes several environmental benefits and a want to reduce environmental taxes imposed by governments. The “carbon footprint” refers to the calculation of carbon generated by hardware (e.g., processors, memory, etc.) using energy consumed by the device in completing a processing task.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration that may be implemented for an organization, such as a business, educational institution, governmental entity, healthcare facility or other organization.

FIG. 2 illustrates a processing pipeline, in accordance with examples discussed herein.

FIG. 3 illustrates a metadata tracking system for implementing carbon footprint measurements of distributed workflows, in accordance with examples discussed herein.

FIG. 4 illustrates a processing pipeline with iterative task generation, in accordance with examples discussed herein.

FIG. 5 is an example computing component that may be used to implement various features of the metadata tracking system in accordance with examples discussed herein.

FIG. 6 illustrates a data lineage for an artifact, in accordance with examples discussed herein.

FIG. 7 is an example computing component that may be used to implement various features of the metadata tracking system in accordance with examples discussed herein.

FIG. 8 is a computing component that may be used to implement examples of the disclosed technology.

The figures are not exhaustive and do not limit the present disclosure to the precise form disclosed.

### DETAILED DESCRIPTION

Any time a task is executed by a processor, the processor can create carbon. To calculate the carbon footprint that is generated when performing a task, the calculation traditionally measures the device's processor usage in performing the task. However, processes that are executed and measured using this traditional calculation of a carbon footprint often leads to inaccurate reporting of the carbon needed to perform the task, because present day processing is often executed on several, distributed systems. These systems may be utilized to execute separate processes prior to or currently to the ultimate task. For example, in machine learning, a traditional calculation of a carbon footprint for executing a machine learning model may only identify carbon for the execution of the inference stage of the model when the model generates a final output. In actuality, the carbon footprint for reaching the inference stage includes several iterative processes that each add to the carbon generation in determining the final output.

In some examples, external machines may perform incremental processing prior to the inference stage, including edge devices, cloud computing nodes, and supercomputers. The prior stages may also produce carbon in association with the processing task. For example, all of the devices may be utilized in creating and training the machine learning model prior to executing the model for inference, even though traditional carbon footprint calculations only calculate the carbon on the machine that determines the final output.

Examples of the present system describe a metadata tracking system that is configured to track and calculate the carbon generated during various iterative processing tasks in distributed systems. For example, the carbon may be calculated for the individual processing stages of a pipeline for generating an artifact (e.g., through a data lineage of process/task executions), generating and utilizing a machine learning model (e.g., as it is generated in stages through the processing pipeline), or other multi-step tasks that may be implemented iteratively and on distributed systems.

The “artifact” corresponds with a data file, machine learning model, metric, or other electronic information encoded in a physical medium that is transformed and processed through different stages of a data lineage. The devices that generate the data artifact (e.g., compute nodes) may generate carbon as they execute machine readable instructions to generate and transform the data artifact at each stage of the data lineage. The carbon footprint value of a data artifact may correspond with an aggregation of the data through each of the stages of the data lineage (e.g., one artifact/carbon footprint value, two artifacts carbon footprint values, or another arbitrary number of artifacts with their carbon footprint values may be aggregated).

The “data lineage” or “lineage” (used interchangeably) of the processing pipeline may trace the artifact to define how it moves and changes through different processing, transformation, and between various systems. The lineage may help define how data for the artifact is obtained and modified as it moves through the computing environment.

The “processing pipeline” is set of steps, implemented by devices that transmit, process, and transform data throughout a computing environment. The processing pipeline may define, for example, how the data is ingested, cleaned, and used through various stages for analysis. The “stages” of the processing pipeline may correspond with a set of task executions that are implemented during the stage. For example, data cleaning may comprise a set of task executions implemented by the device in order to perform the stage within the processing pipeline.

The metadata tracking system may track and store the lineage/dependencies of the data from individual applications. The applications may transmit their metadata to the metadata tracking system via an application programming interface (API) associated with the metadata tracking system. The metadata tracking system may record the metadata associated with an Al execution (e.g., version, hyperparameters, or other metrics) in response to receiving the transmission. The metadata tracking system may organize and index the metadata in a tree hierarchy. The use of the index/organization can expedite any data retrieval tasks that ultimately rely on the metadata. In some examples, the organization can facilitate the tracking of the cumulative carbon footprint of the several systems/devices.

In some examples, the tree hierarchy can organize the applications or devices that are utilized in generating the artifact or trained machine learning model in order to track the carbon footprint from start to finish at the job/pipeline level. In this example, the calculation of the carbon footprint of the job is the sum of the carbon footprint of all its children (stages) and the cumulative carbon footprint corresponds with the leaf nodes of the tree. Application developers can use the logging API provided by the metadata tracking system to tag the job/pipeline and the stage in the job which the current application belongs to.

When individual applications are executed, the metadata tracking system receives the carbon footprint values from the individual applications/devices. When stages are iteratively run, the metadata tracking system can track the rerunning of these stages by maintaining the history of the task executions within the stage that are performed by these applications. The metadata tracking system can aggregate the carbon footprint values collected over time and with each iterative execution of the task/stage. The metadata tracking system can also track processing within the tree hierarchy to determine the cumulated carbon footprint for the overall job/task. This improved process can more accurately track the carbon footprint of the task and potentially work to reduce it.

Additional technical improvements are described throughout the disclosure. For example, it may be technically infeasible to track lineage-based processing in traditional systems, including generating a base machine learning model or fine-tuning the model with domain specific data. The base model could be developed by one device or cluster of devices associated with one entity and the domain-specific fine-tuning may be carried out by a different entity/device. In the improved metadata tracking system, the processing pipeline for the base model can correspond with a first carbon footprint value, which aggregates each of the stages and tasks to generate the next iteration of the model (e.g., the base model). The metadata tracking system can aggregate the next stages of the processing pipeline to determine additional carbon footprint values for the final, usable, trained model (e.g., two, three, or more additional carbon footprint values). Without lineage-based tracking, the carbon footprint of a model that has been fine-tuned may not take into account the carbon footprint of the base model, leading to an inaccurate assessment of the iterative operations performed by the system(s).

Similar systems may be implemented for artifact lineage tracking, where the lineages can be joined together based on their content or corresponding hash values. The combination of the carbon footprint for each processing task may correspond with the carbon footprint for the final artifact. The iterative processing may increase the overall carbon footprint value for the artifact, to help accurately track the entire carbon footprint for generating the artifact based on its lineage and not individual, isolated stages at distributed devices and locations.

In some examples of technical improvements of the metadata tracking system, a first model may be generated by a first device/entity and downloaded by second device/entity, and the second entity can fine-tune the downloaded model to create a second model. In traditional systems, the carbon footprint associated with the first model may not be considered in the overall carbon footprint calculation of the second model because the process of training the model would have been executed on a completely different system and by a completely different entity. In the improved metadata tracking system, the multiple iterations of model training, hyperparameter selection, feature selection, fine-tuning, and other stages of generating a machine learning model may be identified and tracked with the overall carbon footprint for the second model.

In some examples of technical improvements of the metadata tracking system, the carbon footprint can be accurately identified for computational processing involved in fine-tuning the model for different use cases. For example, the base model may be downloaded via a communication network from a first entity and stored in a storage device with a second entity. The second entity may implement a first fine-tuning stage/tasks of the base model to use in a finance domain and implement a second fine-tuning stage/tasks of the base model to use in a medical domain. Carbon footprint values may be determined for the base model and each of the uses of the model in different domains. For example, carbon footprint values may associated with an aggregation of the carbon footprint of the initial, base model and also the carbon footprint generated from fine-tuning the base model to use in each of the different domains.

In some examples of technical improvements of the metadata tracking system, the carbon footprint determination may be standardized across the multiple stages. For example, the process may implement a carbon intensive process earlier in the processing pipeline for the benefit of a lower carbon footprint value later in the processing pipeline. In some examples, the determination of the carbon footprint along each of the stages and tasks of the processing pipeline may identify a lower carbon footprint value overall. This may be especially applicable to a quantized model, which may be associated with a higher carbon footprint value in the initial stages and can be optimized for downstream processing in later stages, leading to lesser overall carbon footprint.

In some examples of technical improvements of the metadata tracking system, the carbon footprint may be accurately determined for models involved in lifelong learning/training, which may continuously adapt the model to the new data (e.g., post-training adaptation). In some examples, the system can retrain the model with additional data whenever a model drift or data drift is observed and the system can track the evolution of the model and the carbon footprint generated with each iteration. The carbon footprint of the model may be the aggregation/sum of carbon footprint of all previous base versions of the model.

In some examples of technical improvements of the metadata tracking system, the carbon footprint may be accurately determined for models that are limited by a maximum signal. The model may be iteratively retrained with additional data that may adjust the maximum signal. The multiple training cycles of the model that adjust the maximum signal may be tracked in the improved system, whereas traditional systems may only track the carbon footprint of the final execution of the final model, thus creating an underrepresentation of the carbon footprint generated by the systems involved in the training/inference. Additionally, the improved system may determine the carbon cost at a job, stage, or task level for the overall model or the generated artifact.

In some examples of technical improvements of the metadata tracking system, the carbon footprint may be accurately determined for lineages that produce artifacts. As an illustrative example, an execution (E1) produces a set of artifacts (A1, A2) as output and consumes energy equivalent to “n.” The system may use the set of artifacts together (A1, A2) and identify the energy contribution (E1) as “n.” For the carbon footprint, the set of artifacts may be considered as a single set when they are used together, rather than individual artifacts, to eliminate double accounting for carbon footprint values. When the artifacts are used separately (e.g., in downstream jobs), the carbon footprint of each artifact may correspond with the energy contribution (E1) as “n” for artifact A1 and also the energy contribution (E1) as “n” for artifact A2.

In some examples of technical improvements of the metadata tracking system, the carbon footprint for processing pipelines may be accurately determined, including processing pipelines that are spread across distributed entities and across multiple locations. For example, the stages in the pipelines may be executed by distributed teams and the improved system can merge the lineage chains together to create a common single lineage chain. In this example, the lineage of artifacts may be merged with a second lineage using the content hash of each artifact and merging a subtree illustrating the processing pipeline to the second tree (e.g., based on the parent names). The merging process can enable a determination of the carbon footprint for distributed lineages and track the carbon footprint across distributed entities and across multiple locations.

In some examples of technical improvements of the metadata tracking system, the carbon footprint may be associated with a location and track the location where the artifact/pipeline was executed. For example, in the same lineage, there could be compute nodes that execute different tasks in different geographical regions and the carbon cost of the carbon footprint value may vary based on the locations. The improved system may implement fine-grained tracking of executions and stitch together lineages. The stitching of lineages may be based on executions and artifacts, which enables the system to associate the correct carbon cost based on the location the pipeline/lineage was executed, instead of a generalized carbon estimate across all the locations.

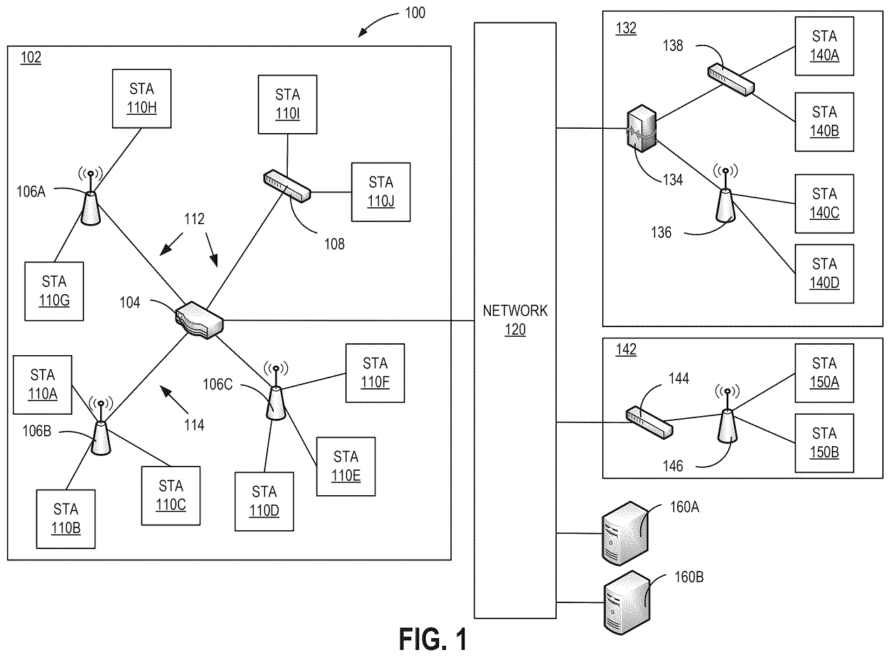

Before describing various examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. Network configuration 100 may include primary site 102 in communication with network 120. Network configuration 100 may also include one or more remote sites 132, 142, each of which may be components of the processing pipeline for generating artifacts or stages of the processing pipeline and, in some cases, generating carbon from the creation of the artifact or processing stages of a job. The artifacts may correspond with data, machine learning models, metrics, or other electronic information encoded in a physical medium. In some examples, multiple client devices 110 located at site 102, as well as other devices at other sites may contribute to the carbon footprint of the processing tasks.

Primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, primary site 102 includes controller 104, which is in communication with network 120. Controller 104 may provide communication with network 120 for primary site 102. There may be other points of communication with network 120 for primary site 102 in addition to controller 104. Although single device associated with controller 104 is illustrated, primary site 102 may include multiple controllers and/or multiple communication points with network 120. In some examples, controller 104 may communicate with network 120 through a router. In other examples, controller 104 provides router functionality to the devices in primary site 102. In this specification, the word “tunnel” refers to an encapsulated mode of transporting data between AP and controller.

Controller 104 may be operable to configure and manage network devices, such as at primary site 102, and may also manage network devices at remote sites 132, 142. Controller 104 may be operable to configure and/or manage switches, routers, access points, and/or client devices connected to a network. Controller 104 may itself be, or provide the functionality of, an Access Point (AP).

Controller 104 may be in communication with one or more switches 108 and/or wireless Access Points (APs) 106a-c. Switches 108 and wireless APs 106a-c provide network connectivity to various client devices 110a-j. Using a connection to switch 108 or AP 106a-c, client device 110a-j may access network resources, including other devices on the (primary site 102) network and network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within primary site 102, switch 108 is included as one example of a point of access to the network established in primary site 102 for wired client devices 110i-j. Client devices 110i-j may connect to switch 108 and through switch 108, may be able to access other devices within network configuration 100. Client devices 110i-j may also be able to access network 120, through switch 108. Client devices 110i-j may communicate with switch 108 over a wired or wireless connection 112. In the illustrated example, switch 108 communicates with controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by controller 104. APs 106a-c communicate with controller 104 and the network over connections 112, which may be either wired or wireless interfaces.

Network configuration 100 may include one or more remote sites 132. Remote site 132 may be located in a different physical or geographical location from primary site 102. In some cases, remote site 132 may be in the same geographical location, or possibly the same building, as primary site 102, but lacks a direct connection to the network located within primary site 102. Instead, remote site 132 may utilize a connection over a different network, e.g., network 120. Remote site 132 such as the one illustrated in FIG. 1 may be a satellite office, another floor or suite in a building, for example. Remote site 132 may include gateway device 134 for communicating with network 120. Gateway device 134 may be a router, a digital-to-analog modem, a cable modem, a digital subscriber line (DSL) modem, or some other network device configured to communicate with network 120. Remote site 132 may also include switch 138 and/or AP 136 in communication with gateway device 134 over either wired or wireless connections. Switch 138 and AP 136 provide connectivity to the network for various client devices 140a-d.

In various examples of the disclosure, the set of processing tasks in the processing pipeline involve communications over network 120. For example, a device at the first processing site generates a first artifact that is provided over network 120 to a second processing site, which generates a second artifact. The first artifact and second artifact may be combined to construct a final product, or in some examples, the first artifact may be used as input to generate the second artifact as output, which is then used to construct a final artifact. In some examples, the processing pipeline may include both the first processing site and the second processing site.

Various carbon footprint values may be determined at any or all of these locations and devices. For example, the carbon footprint of generating the artifact may be determined as well as any processing tasks at various stages of a processing pipeline. The processing tasks may involve the artifact or other data.

The carbon footprint may comprise an aggregation of the carbon generated for each of the set of processing tasks at each of the data processing sites. In some examples, the carbon footprint may also comprise any of the iterative processing for processing tasks that generate artifacts that is repeated at any of the sites.

In various examples, remote site 132 may be in direct communication with primary site 102, such that client devices 140a-d at remote site 132 access the network resources at primary site 102 as if these client devices 140a-d were located at primary site 102. In such examples, remote site 132 is managed by controller 104 at primary site 102, and controller 104 provides the necessary connectivity, security, and accessibility that enable the connection between remote site 132 and primary site 102. Once connected to primary site 102, remote site 132 may function as a part of a private network provided by primary site 102.

In various examples, network configuration 100 may include one or more smaller remote sites 142, comprising gateway device 144 for communicating with network 120 and wireless AP 146, by which various client devices 150a-b access network 120. Examples of remote site 142 may represent, for example, an individual employee's home or a temporary remote office. Remote site 142 may also be in communication with primary site 102, such that client devices 150a-b at remote site 142 access network resources at primary site 102 as if these client devices 150a-b were located at primary site 102. Remote site 142 may be managed by controller 104 at primary site 102 to make this transparency possible. Once connected to primary site 102, remote site 142 may function as a part of a private network provided by primary site 102.

Network 120 may be a public or private network, such as the Internet, or other communication network to allow connectivity among various sites 102, 132, 142 as well as access to servers 160a-b. Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100 but that facilitate communication between the various parts of the network configuration 100, and between the network configuration 100 and other network-connected entities. Network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. Client devices 110a-j, 140a-d, 150a-b may request and access the multimedia content provided by content servers 160a-b.

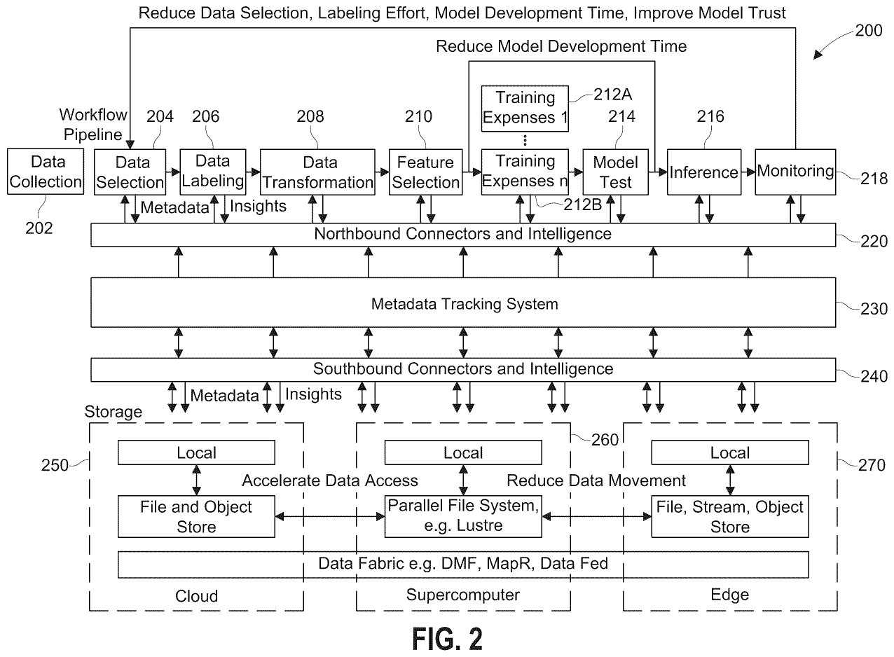

FIG. 2 illustrates a processing pipeline, in accordance with examples discussed herein. In example 200, the processing pipeline is associated with stages of executing a machine learning model, where each stage may correspond with a carbon footprint value. The carbon footprint values may be associated with execution of a processor at that respective stage. In this example, the stages comprise data collection 202, data selection 204, data labeling 206, data transformation 208, feature selection 210, a set of training stages 212 (e.g., first training stage 212A, second training stage 212B), model testing 214, inference 216, and monitoring 218. The processing pipeline may follow the model or other data through stages 202-218. Additional or fewer stages may be included with the processing pipeline without diverting from the essence of the disclosure.

Data collection 202 comprises a systematic gathering of raw data from various sources. Sources may be identified based on the type of data that needs to be collected. Sources can include databases, APIs, files, sensors, web scraping tools, or other data stores.

Data selection 204 comprises receiving data from the identified sources. In some examples, the selection may filter or remove data from the collection process.

Data labeling 206 comprises identifying structure and labels for the data. In some examples, the labels are identified from metadata that includes information such as data source, timestamp of collection, data format, and any other contextual information for the data.

Data transformation 208 comprises bringing the extracted data into the processing pipeline. The transformation may include altering the data into a format suitable for processing and analysis. The data may be refined or otherwise altered. In some examples, data may be cleaned or normalized. In some examples, the transformation may merge data based on common identifiers or keys that can be used to help join or aggregate the data.

Feature selection 210 comprises choosing a subset of relevant features from the original set of features in a dataset to reduce the dimensionality of the data and to select those features that are most informative for the predictive modeling task.

Training stages 212 comprises the steps of training the model using data that has been collected, preprocessed, and organized. In some examples, the data is split in a training set, validation set, and a test set, so that a subset of the data is used for training. The training process may also select a machine learning algorithm based on the nature of the problem (e.g., regression, classification, clustering) and, during the training, optimize the settings of the chosen algorithms to achieve the best performance on the validation set.

Model testing 214 comprises calculating various performance metrics (e.g., accuracy, precision, recall, F1-score, RMSE) to assess how well the model performs. In some examples, the model testing stage may comprise visualizing results and model behavior to gain insights and interpretability.

Inference 216 comprises using the trained model in a production system or workflow where it can be used to make predictions or decisions. The data provided as input to the trained machine learning model may generate the predictions based on new, unseen data or data was previously separated from the training data for inference purposes.

Monitoring 218 comprises tracking the model performance during the deployment or inference stage of the model implementation. Monitoring may also analyze the execution and iteration of the inference process based on new data or changing conditions.

In some examples, the stages of a processing pipeline are executed on different systems with different carbon footprint values. Some stages may be implemented sequentially after the previous stage has completed and the output from the stage has been transmitted to a device processing the next stage or at a different data processing site.

In some examples, the stages of the processing pipeline comprise lifelong learning/training and post-training adaptation of the model to new data. In some examples, the system can retrain the model with additional data whenever a model drift or data drift is observed and the system can track the evolution of the model and the carbon footprint generated with each iteration.

In some examples, one of the stages of the processing pipeline comprise deployment of the model. In some examples, the deployment of the model involves inference 216 and monitoring 218, or may comprise an analysis of the execution of the inference process based on new data or changing conditions.

In some examples, metadata tracking system 230 may communicate with several data processing sites in order to implement the stages of the processing pipeline. For example, metadata tracking system 230 may communicate via a first communication framework 220 to access the stages of the processing pipeline.

The communication from metadata tracking system 230 via first communication framework 220 to stages 202-218 may utilize an agent or library associated with metadata tracking system 230. The agent may access stages 202-218 using first communication framework 220 and individual agents may separately access each of the stages. In some examples, each agent is executed concurrently with each stage to capture the metadata related to processing at that particular stage. It can also capture the carbon footprint at that bare metal state of the device that is executing the process.

In some examples, the agent may correspond with a library (e.g., Experiment Tracker). In this example, the library may help determine the carbon footprint for a particular experiment by tracking the processing executions throughout multiple iterations of the bare metal hardware during the task/job.

In some examples, the agent may determine the carbon (e.g., by the library) for each node in the tree hierarchy and aggregate the carbon value returned by each node for a cumulative carbon footprint.

In an illustrative example, Kubernetes® may be executed with an agent to collect telemetry data. When external agents are utilized with the service (e.g., at a third party entity/device), the agent may determine the telemetry from external agent as well (e.g., ECHO burner tests system). The agent associated with metadata tracking system 230 may determine the carbon and utilization for the ports accessed by the service and then calculate the carbon footprint. In another example, a logger service may transmit the carbon data (e.g., as metadata) back to metadata tracking system 230 for calculation of the overall carbon footprint at that stage. The carbon for that agent may be associated with the stage along the lineage of the processing pipeline.

When an agent accompanies the third party processing, the agent may be implemented as a library or Docker agent and identify each of the stages and nodes that are being utilized in that processing. The agent may be approved to operate within the third party system. In this example, the agent may be configured to execute processes associated with metadata tracking system 230 to transmit metadata via an accessible API of the metadata tracking system.

Metadata tracking system 230 may also communicate with several data processing sites via a second data processing framework 240. The data processing sites may comprise, for example, cloud system 250, supercomputer 260, and client/edge devices 270. These data processing sites may provide illustrative locations for storing and processing data. The data processing sites may also produce the physical carbon that is tracked by the agent/library (as part of the processing pipeline) and the metadata may be transmitted to metadata tracking system 230 via second data processing framework 240.

Cloud system 250 comprises a set of storage devices, including a local data store, file and object data store, or a data fabric. The file and object data store may communicate with supercomputer 260 and client/edge devices 270 to accelerate data access, reduce data movement, or otherwise improve access to data for calculation of the carbon footprint.

Supercomputer 260 comprises a set of storage devices, including a local data store, parallel file system, or a data fabric. The parallel file system may communicate with cloud system 250 and client/edge devices 270 to accelerate data access, reduce data movement, or otherwise improve access to data for calculation of the carbon footprint.

Client/edge devices 270 comprises a set of storage devices, including a local data store, file, stream, and object data store, or a data fabric. The file, stream, and object data store may communicate with cloud system 250 and supercomputer 260 to accelerate data access, reduce data movement, or otherwise improve access to data for calculation of the carbon footprint.

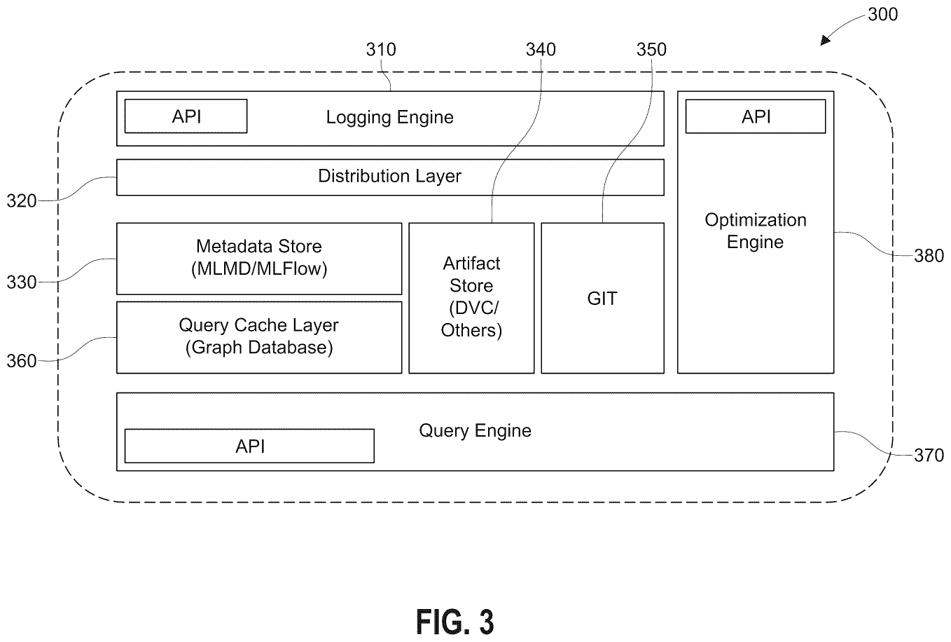

FIG. 3 illustrates a metadata tracking system for implementing carbon footprint measurements of distributed workflows, in accordance with examples discussed herein. In example 300, metadata tracking system may comprise various engines, data stores, and data layers, including logging engine 310, distribution layer 320, metadata store 330, artifact store 340, GIT 350, query cache layer 360, query engine 370, and optimization engine 380.

Logging engine 310 is configured to receive metadata from distributed processing pipelines. The metadata may be stored in a corresponding data store. In some examples, the metadata may define a stage in the processing pipeline (e.g., data selection, labeling, or other preprocessing), a source device that generated the metadata, the hyper parameters that the model is using to execute the task/job, the computing environment where the metadata was generated, and other information. The metadata may be received via a corresponding API associated with logging engine 310 in a format defined by the API.

Distribution layer 320 is configured to collect the metadata from various distributed data processing sites and join that metadata together to a single lineage chain or a single hierarchy. In some examples, the metadata can be aggregated or combined from the distributed data processing sites to form the single lineage/tree.

Metadata store 330 is configured to store metadata. In some examples, the metadata may comprise data associated with the type of processing pipeline for the system. As such, a machine learning model pipeline may have machine learning metadata stored in metadata store 330, including a universal unique identifier (UUID), artifact/model version number, hash value, and other metadata. In another example, metadata corresponding with third party entities may be stored in stored in metadata store 330. In some examples, the third party entities (e.g., MLMD or MLFlow metadata data stores) can provide data to metadata store 330. In these examples, any type of data associated with the processing pipelines, metadata, machine learning models, or the like can be stored in these data stores. Other data may be stored with metadata store 330 without diverting from the essence of the disclosure.

In some examples, each execution is identified uniquely by its UUID that is stored in metadata store 330. In this way, every execution may be distinct from every other execution, and each of the executions may be individually by the system. When the system aggregates the carbon footprint for each execution, it may also identify unique executions, through the use of unique UUID instances. The unique UUIDs may be aggregated for all the executions for a particular stage of a processing pipeline.

In some examples, the lineage of an artifact may be identified by the UUID as well. The system may determine an iteration of a task, where each execution of the task corresponds with a unique UUID. For example, the carbon footprint for a particular artifact of version A may identify the lineage of that artifact alone, where it may correspond with execution A having a first UUID from stage one, plus execution B having a second UUID from stage two. The two carbon footprint values corresponding with the two UUIDs may be aggregated to determine the carbon footprint value for the artifact during the two executions. In another example, stage A could have ten different executions, but only one of them is actually leading to the final artifact. In this instance, the system may identify one execution of stage A and one execution of stage B which led to the final artifact.

In comparison, a processing pipeline may use the unique UUIDs to identify carbon footprints for each of the iterative stages and tasks. For example, in a processing pipeline for training an image detection model, the system may identify the carbon footprint value corresponding with the unique UUIDs for the executions of a first stage, the carbon footprint value corresponding with the unique UUIDs for the executions of a second stage, and so on. As such, various carbon footprint calculations corresponding with the UUIDs may be implemented.

Artifact store 340 is also configured to store the electronic files of the artifact such as dataset file, metrics file, model file, metadata, or other electronic information. The data/metadata associated with the artifacts may comprise version information, type of the data used, and model version, for example, may be stored in artifact store 340. In some examples, the input artifact, the intermediate artifact, and the output artifact that is produced by the model may be stored.

GIT 350 is configured to store software code associated with a software application. The code may correspond with the agent (that is executed with the stages of the processing pipeline) or other compiled or non-compiled executable associated with the processing pipeline.

Query cache layer 360 or graph database is configured to provide an interface for a user to query relationships between artifacts, lineages, or stages of the processing pipeline. The query may comprise, for example, an interface to determine the input, output, level of the lineage, portions of the hierarchy, transformations that are implemented with the data, and so on.

Query engine 370 is configured to provide application programming interfaces (APIs) to access the data, in association with query cache layer 360. The query may identify any data that is stored in metadata store 330, including determining a number of processing pipelines that may be involved with a particular job/task, determining the carbon footprint for a particular artifact, or determining the carbon footprint for a particular job.

Optimization engine 380 is configured to determine a set of parameters that exceed a threshold value for a completed task. The parameters may be stored and used in future processing tasks, or optimized through iterative processing to determine a more efficient or accurate process for generating the data. In some examples, optimization engine 380 may optimize the parameters to reduce a carbon footprint of a future task/job.

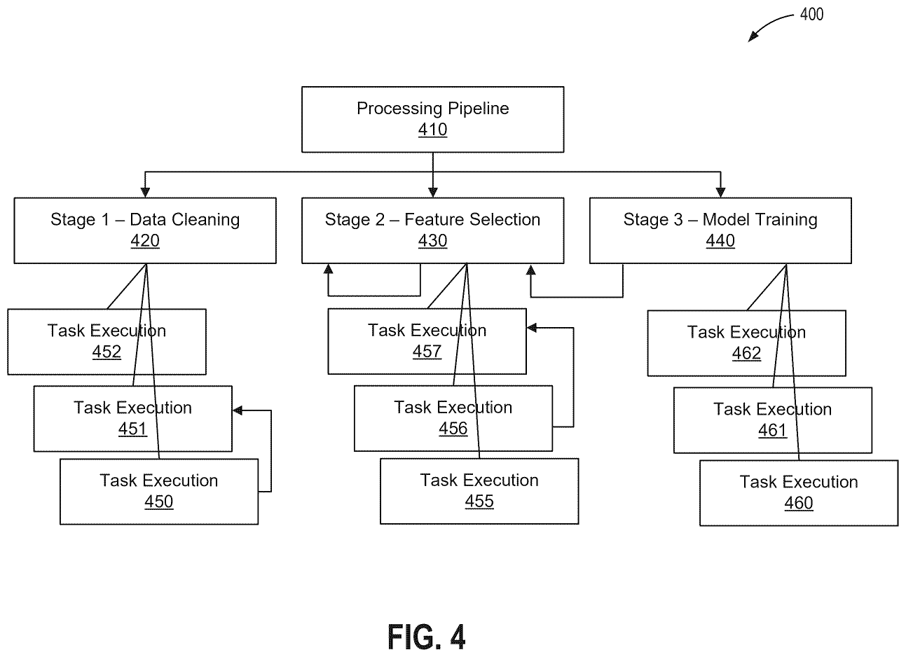

FIG. 4 illustrates a processing pipeline with iterative task generation, in accordance with examples discussed herein. In example 400, processing pipeline 410 may be organized in a tree data structure with nodes of the tree representing the stages and task execution of the processing pipeline. In this example, processing pipeline 410 comprises a first stage 420 (e.g., data cleaning), second stage 430 (e.g., model training), and third stage 440 (e.g., inference), and each of the stages may comprise various executions of tasks 450.

As an illustrative example, the carbon footprint for training a machine learning model for an image detection inference task involves execution of stages and tasks to train the model. The carbon footprint of the image detection task may be an aggregation of the cumulative carbon footprints of all the stages of the task, and the carbon footprint of each stage may be the cumulative carbon footprint of all the task executions in that stage. For example, if training the model includes three stages, like data cleaning, feature detection, and model training, and each stage would include three task executions, then the carbon footprint of that entire task to train the machine learning model is the sum of all the three executions in each individual stages and the sum of all the task executions within each stage.

Various stages may implement sequential or iterative processing. In this illustration, several tasks 450, 451, 452 of first stage 420 corresponding with data cleaning are iteratively executed, several tasks 455, 456, 457 of second stage 430 corresponding with feature selection are iteratively executed, several tasks 460, 461, 462 of third stage 440 corresponding with model training are iteratively executed. Any of these tasks may be iteratively executed to repeat the execution of the task more than once.

The tasks within the stages may also be sequentially or iteratively executed. In this example, tasks 450, 451, 452 corresponding with data cleaning in first stage 420 is executed, then tasks 455, 456, 457 corresponding with feature selection in second stage 430 is executed, and tasks 460, 461, 462 corresponding with model training in third stage 440 is executed. The stages may also be sequentially executed, for example, first stage 420, then second stage 430, and then third stage 440, one or more of them being iteratively executed.

In some examples, the iterative process may be implemented as part of a training of a machine learning model. For example, a first training experiment may be initiated and the output of the first training experiment can be provided to the model testing stage. A second training experiment may be initiated and the output of the second training experiment can be provided back to the model testing stage. The model may be iteratively improved by using the testing and experimentation stages. Data may be added to the trained model to improve it.

In some examples, the iterative process may be implemented to train multiple models. The models may be trained using sequential and iterative processing until the parameter associated with the model exceeds a threshold value. Each of the iterations of the training may be aggregated to the carbon footprint of the task/job.

In the iterations of the task, the system may aggregate the carbon footprint value associated with that iterative task to determine a total carbon footprint value overall. For example, the carbon footprint value for the final model production may be an aggregate of the carbon footprint values for each of the iterations of the tasks (e.g., selection, labeling, feature selection, etc.).

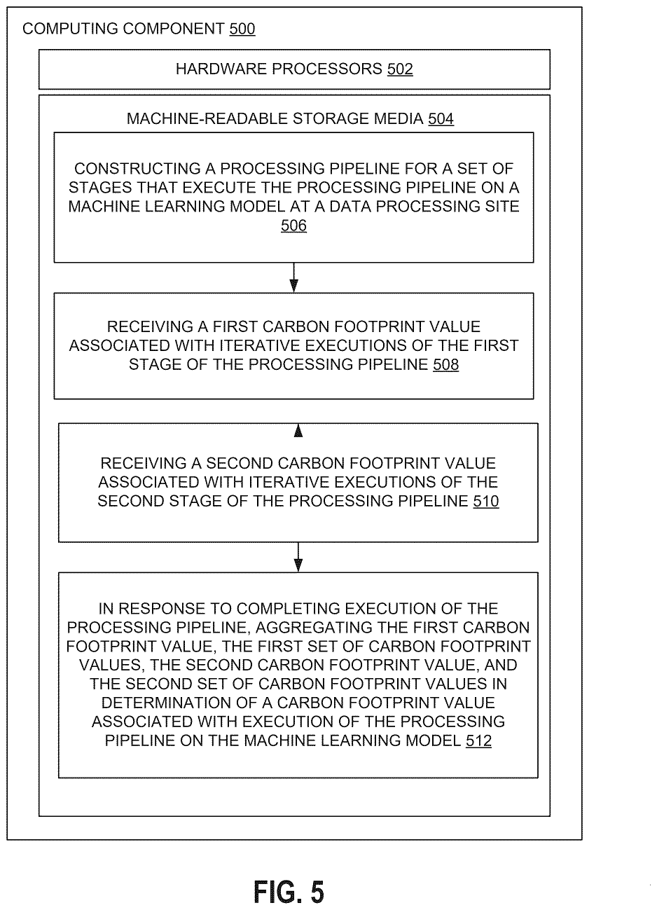

FIG. 5 illustrates a computing component that may be used to implement lineage-based classification, in accordance with various examples of the disclosed technology. For example, computing component 500 may be a server computer, a controller, or any other similar computing component capable of processing data. In the example implementation of FIG. 5, computing component 500 includes hardware processor 502 and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-512, to control processes or operations for a lineage-based classification of network events. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-512.

Hardware processor 502 may execute instruction 506 to construct a processing pipeline for a set of stages that execute the processing pipeline on a machine learning model at a data processing site. The processing pipeline may be constructed by the metadata tracking system, illustrated as computing component 500.

The data processing site may comprise one of multiple physical or geographical sites, including a primary site and remote sites, each of which may be components of the processing pipeline for generating artifacts and, in some cases, generating carbon from the creation of the artifact and processing stages of a job.

Hardware processor 502 may execute instruction 508 to receive a first carbon footprint value associated with iterative executions of a first stage of the processing pipeline. The first stage may comprise a first set of task executions within the processing pipeline. In some examples, each of the first set of task executions may correspond to a first set of carbon footprint values. For example, the stages of the processing pipeline may generate several artifacts at several different devices, including the stages of data collection, data selection, data labeling, data transformation, feature selection, a set of training stages (e.g., first training stage, second training stage), model testing, inference, and monitoring. Additional or fewer stages may be included with the processing pipeline without diverting from the essence of the disclosure.

In some examples, an agent or library is utilized to track the carbon/processing along the processing pipeline. The agent may access the multiple stages or individual agents may separately access each of the stages and report it back to the metadata tracking system. In some examples, each agent is executed concurrently with each stage to capture the metadata related to processing at that particular stage. It can also capture the carbon footprint at that bare metal state of the device that is executing the process.

In some examples, the agent may correspond with a library (e.g., Experiment Tracker). In this example, the library may help determine the carbon footprint for a particular experiment by tracking the processing executions throughout multiple iterations of the bare metal hardware during the task/job. In other examples, the agent may determine the carbon (e.g., by the library) for each node in the tree hierarchy and aggregate the carbon value returned by each node for a cumulative carbon footprint.

In some examples, external agents are used to report the carbon at each stage of the processing pipeline. When external agents are utilized with the service (e.g., at a third party entity/device), the agent may determine the telemetry from external agent as well (e.g., ECHO burner tests system). The agent may determine the carbon and utilization for the ports accessed by the service and then calculate the carbon footprint. In another example, a logger service may transmit the carbon data (e.g., as metadata) back to metadata tracking system for calculation of the overall carbon footprint at that stage. The carbon for that agent may be associated with the stage along the lineage of the processing pipeline.

Hardware processor 502 may execute instruction 510 to receive a second carbon footprint value associated with iterative executions of a second stage of the processing pipeline. The second stage comprising a second set of task executions within the second stage of the processing pipeline. In some examples, each of the second set of task executions corresponding to a second set of carbon footprint values.

Hardware processor 502 may execute instruction 512 to aggregate the first carbon footprint value, the first set of carbon footprint values, the second carbon footprint value, and the second set of carbon footprint values. The aggregation may be in determination of a carbon footprint value associated with execution of the processing pipeline on the machine learning model. In some examples, the aggregation is in response to completing execution of the processing pipeline.

In some examples, the metadata can be aggregated or combined from the distributed data processing sites to form the single lineage/tree.

In some examples, each execution is identified uniquely by its UUID. In this way, every execution may be distinct from every other execution, and each of the executions may be individually by the system. When the system aggregates the carbon footprint for each execution, it may also identify unique executions, through the use of unique UUID instances. The unique UUIDs may be aggregated for all the executions for a particular stage of a processing pipeline.

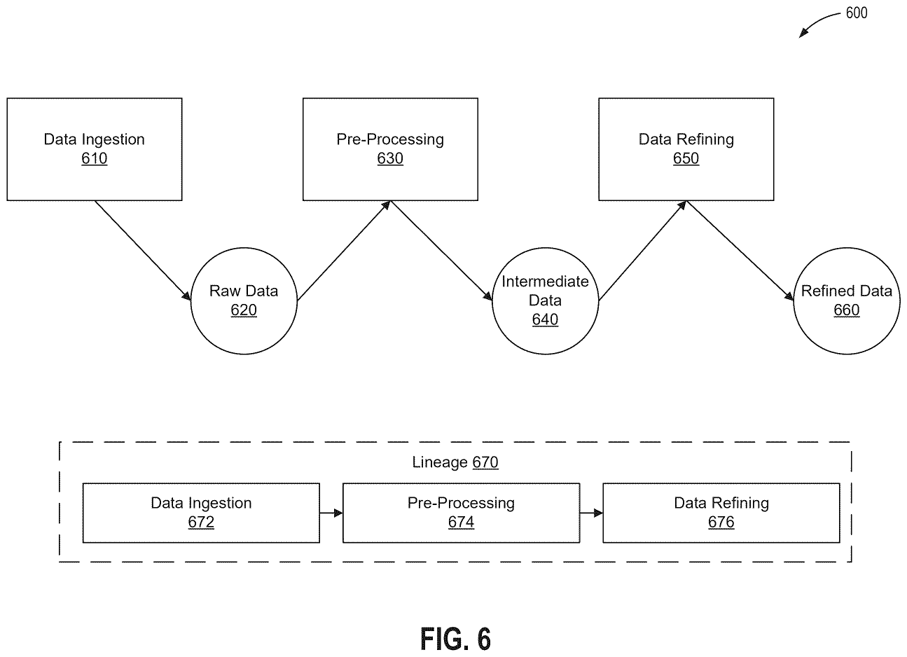

FIG. 6 illustrates a data lineage for an artifact, in accordance with examples discussed herein. In example 600, a set of execution steps are illustrated with different versions of the same initial artifact as it progresses through the data lineage. The stages or set of execution steps of the lineage comprise data ingestion 610, pre-processing 630, and data refining 650. The artifact along the data lineage comprises raw data 620, intermediate data 640, and refined data 660. In this example, the system illustrates the technical solution to the problems associated with determining the carbon footprint value across distributed systems by tracking the code, data, and metadata together for end-to-end traceability.

The process illustrated in example 600 can help calculate the carbon footprint of an artifact using its data lineage. The data lineage may track the processing of the artifact from distributed sites. For example, the processing pipeline may convert raw data 620 to intermediate data 640 to refined data 660, each of which may correspond with a single artifact. In this example, the artifact undergoes multiple stages split across different devices or processing stages of the processing pipeline. The carbon footprint of the artifact may be calculated as the cumulative sum of the carbon footprint across the different processing stages, including for example, data ingestion 610, pre-processing 630, and data refining 650.

In this example, the data lineage of the artifact may be tracked to get the cumulative carbon footprint of refined data 660. For example, the individual execution lineage under individual stages can be identified and added to determine the cumulative carbon footprint for the artifact. In other examples, individual processing stages that generate energy can be calculated and stored in a lineage tracking tool, like the metadata tracking system, and individual applications can generate/log their metadata to the metadata tracking system (e.g., data ingestion 610, pre-processing 630, data refining 650) as metadata associated with the artifact.

In some examples, the different iterations of the artifact (e.g., as raw data 620, intermediate data 640, refined data 660, etc.) corresponds with the versions of the artifact. The version may be stored as metadata with the artifact and the system may increment the version automatically using a data versioning framework (e.g., Data Version Control (DVC) or other versioning application).

For example, the system may store the Git commit identifier (e.g., as a unique identifier for a commit command to a Git repository) as metadata. The Git commit identifier may correspond with the metadata file associated with the artifact and content hash of the artifact. The system may provide an application programming interface (API) to track the hyper parameters and other metadata of the processing pipelines. In some examples, the system can identify the metadata stored with the data, including the hyper parameters, code version, and the artifact version used for the data processing job or other process. This is used to store the data lineage details and corresponding power, energy, and carbon parameters.

In some examples, the carbon footprint of the compute nodes that execute portions of the data lineage can be determined. For example, the carbon footprint of the node that executes the process can be added as metadata to the property of the node. The nodes in the lineage chain may each include the property that corresponds with the carbon footprint value. This chaining of executions helps to calculate the carbon footprint at any point in the chain. For example, the process may first build the lineage for the executions and artifacts, then add individual carbon metrics for each node in the lineage chain collected using other tools. With this data, the process can calculate the cumulative carbon footprint of any stage in the data lineage.

As an illustrative example, at a third stage of the data lineage, the carbon footprint is the aggregation/sum of all the prior execution stages. If the artifact is produced from the third stage, its carbon footprint is the carbon foot print of the third stage. Whereas if an intermediate artifact is produced in the second stage, its carbon footprint is the sum of first stage carbon value aggregated/sum with the second stage carbon value.

In some examples, the lineage 670 of the data artifact comprises data ingestion 672, pre-processing 674, and data refining 676 as separate task executions. Example lineage 670 corresponds with a linear chain of the artifact, where the output of a task execution feeds into the next task execution as input. Each of the task executions may be iteratively processed and executed, and the carbon footprint from each task may be aggregated to form the carbon footprint for the artifact.

In some examples, the carbon footprint is determined through each task that may alter or change the artifact. The carbon footprint of the artifact may be the carbon footprints of the lineages that generates the artifact. For example, data may be input as Artifact A during data ingestion 672 to generate Artifact B. Artifact B may be taken as input to pre-processing 674 to generate Artifact C. Artifact C may be taken as input to data refining 676 to generate a final artifact. The carbon footprint of the final artifact may be the aggregation of the carbon footprint values from each of the stages in the lineage 670, including carbon footprint values from each of data ingestion 672, pre-processing 674, and data refining 676.

In some examples, the artifact is generated as a single execution lineage chain. For example, from a first task execution (data ingestion 672), a first artifact is generated as output. The output artifact may be consumed by a second task execution (pre-processing 674) as input, absent consideration for the executions that went into the generating the artifact (e.g., tasks 450, 451, 452 corresponding with data cleaning in first stage 420 in FIG. 4). In this case, the execution of second task execution (pre-processing 674) receives an input from the prior step in the lineage chain and produces an output that is consumed by the next step in the lineage chain. The output from the second task execution may be consumed by the third task execution (data refining 676) as input. In this instance, the output from the third task may correspond with the final artifact and the carbon footprint may correspond with each of the input that the steps in the lineage chain received and produced (e.g., task 450 in FIG. 4 alone, not including tasks 451, 452 in FIG. 4 because tasks 451, 452 did not contribute to the version of the artifact that was used as input in the lineage, as shown with raw data 620, intermediate data 640, and refined data 660 in FIG. 6).

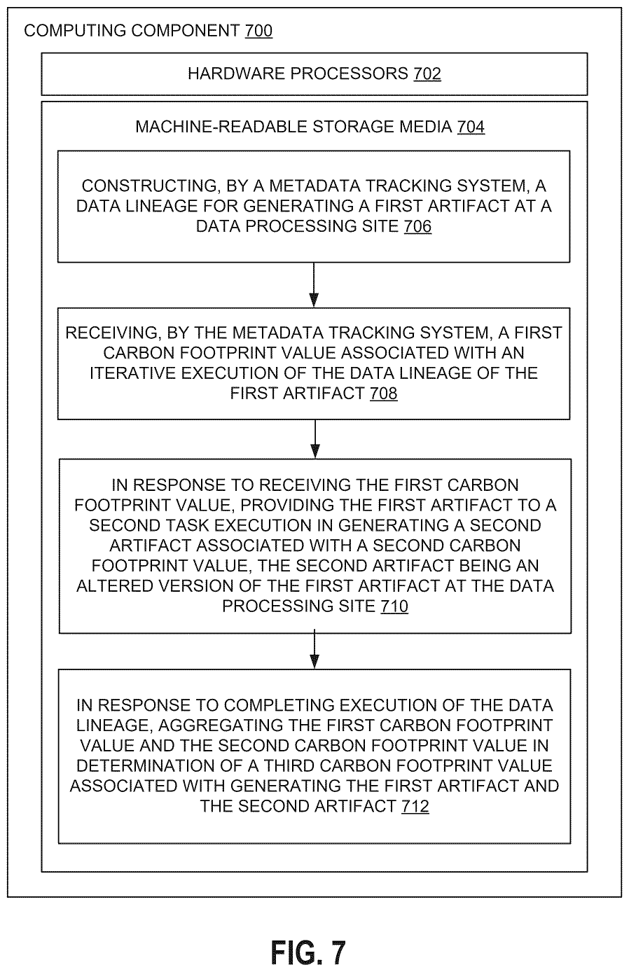

FIG. 7 illustrates a computing component that may be used to implement a lineage-based classification of network events, in accordance with various examples of the disclosed technology. For example, computing component 700 may be a server computer, a controller, or any other similar computing component capable of processing data. In the example implementation of FIG. 7, computing component 700 includes hardware processor 702 and machine-readable storage medium 704.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-712, to control processes or operations for a lineage-based classification of network events. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-712.

Hardware processor 702 may execute instruction 706 to construct a data lineage for generating a first artifact at a data processing site. The data lineage may be constructed by the metadata tracking system, illustrated as computing component 700.

The data processing site may comprise one of multiple physical or geographical sites, including a primary site and remote sites, each of which may be components of the data lineage. The devices may alter the artifact and, in some cases, generate carbon during the creation/altering of the artifact.

Hardware processor 702 may execute instruction 708 to receive a first carbon footprint value associated with an iterative execution of the data lineage of the first artifact. Illustrative examples of the data lineage may comprise data ingestion, pre-processing, and data refining.

In some examples, an agent or library is utilized to track the carbon/processing along the data lineage. The agent may access devices that execute operations to generate the data artifact, determined by individual agents or libraries, and report it back to the metadata tracking system. In some examples, each agent is executed concurrently with each stage of the data lineage to capture the metadata related to processing at that particular stage. It can also capture the carbon footprint at that bare metal state of the device that is executing the process.

In some examples, the agent may correspond with a library (e.g., Experiment Tracker). In this example, the library may help determine the carbon footprint for a particular experiment by tracking the processing executions throughout multiple iterations of the bare metal hardware. In other examples, the agent may determine the carbon (e.g., by the library) for each node in the tree hierarchy and aggregate the carbon value returned by each node for a cumulative carbon footprint.

In some examples, external agents are used to report the carbon at each stage of the data lineage. When external agents are utilized with the service (e.g., at a third party entity/device), the agent may determine the telemetry from external agent as well (e.g., ECHO burner tests system). The agent may determine the carbon and utilization for the ports accessed by the service and then calculate the carbon footprint. In another example, a logger service may transmit the carbon data (e.g., as metadata) back to metadata tracking system for calculation of the overall carbon footprint by that device. The carbon for that agent may be associated with the stage along the data lineage.

Hardware processor 702 may execute instruction 710 to provide the first artifact to a second task execution in generating a second artifact associated with a second carbon footprint value. The second artifact may be an altered version of the first artifact at the data processing site. The first artifact may be provided to the second task and the second artifact may be generated in response to receiving the first carbon footprint value or the first artifact.

Hardware processor 702 may execute instruction 712 to aggregate the first carbon footprint value and the second carbon footprint value in determination of a third carbon footprint value associated with generating the first artifact and the second artifact. The aggregation may be executed in response to completing execution of the data lineage.

In some examples, the metadata can be aggregated or combined from the distributed data processing sites to form the single data lineage.

In some examples, each execution is identified uniquely by its UUID. In this way, every execution may be distinct from every other execution, and each of the executions may be individually by the system. When the system aggregates the carbon footprint for each execution, it may also identify unique executions, through the use of unique UUID instances. The unique UUIDs may be aggregated for all the executions for the data lineage.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

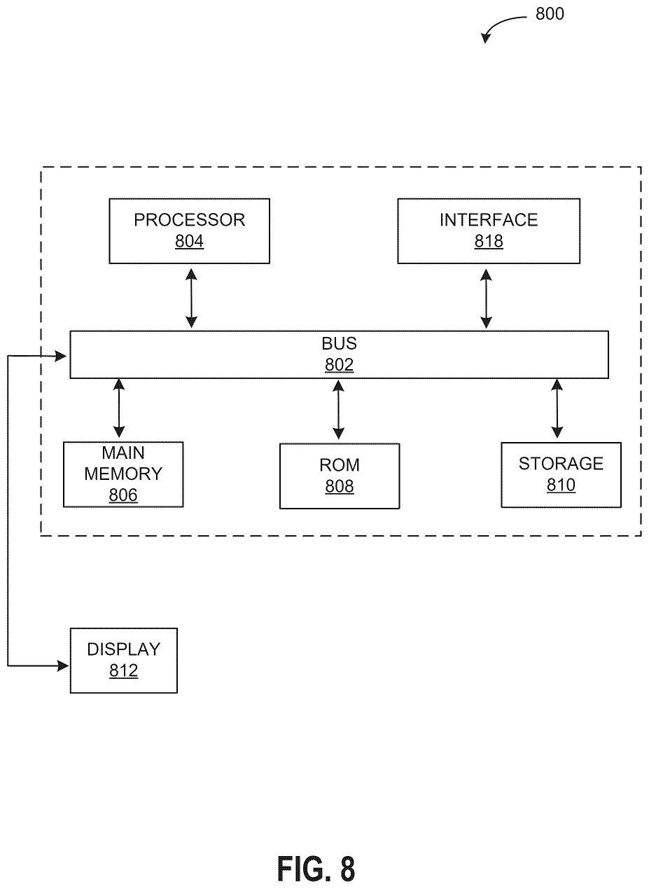

FIG. 8 depicts a block diagram of an example computer system 800 in which various examples of the disclosed technology described herein may be implemented. Computer system 800 includes bus 802 or other communication mechanism for communicating information, one or more hardware processors 804 coupled with bus 802 for processing information. Hardware processor(s) 804 may be, for example, one or more general purpose microprocessors.

Computer system 800 also includes main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

Computer system 800 further includes read only memory (ROM) 808 or other static storage device coupled to bus 802 for storing static information and instructions for processor 804. Storage device 810, such as a magnetic disk, optical disk, or USB thumb drive (Flash drive), etc., is provided and coupled to bus 802 for storing information and instructions.

Computer system 800 may be coupled via bus 802 to display 812, such as a liquid crystal display (LCD) (or touch screen), for displaying information to a computer user. The information may include, for example, the devices associated with each cluster, the changes in new or persistent lineages over time, or summaries of the issues associated with taking an action for the new issue, among other information that may be displayed.

Computer system 800 may include a user interface module to implement a GUI to provide to display 812. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,“ and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 800 may implement the techniques described herein using customized hard-wired logic, one or more ASICs or FPGAs, firmware and/or program logic which in combination with the computer system causes or programs computer system 800 to be a special-purpose machine. According to one example of the disclosed technology, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

Computer system 800 also includes interface 818 coupled to bus 802. Interface 818 provides a two-way data communication coupling to one or more network links that are connected to one or more local networks. For example, interface 818 may be an integrated services digital network (ISDN) card, cable modem, satellite modem, or a modem to provide a data communication connection to a corresponding type of telephone line. As another example, interface 818 may be a local area network (LAN) card to provide a data communication connection to a compatible LAN (or WAN component to communicate with a WAN). Wireless links may also be implemented. In any such implementation, interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 818, which carry the digital data to and from computer system 800, are example forms of transmission media.

Computer system 800 can send messages and receive data, including program code, through the network(s), network link and interface 818. In the Internet example, a server might transmit a requested code for an application program through the Internet, the ISP, the local network and interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A computer-implemented method comprising:
constructing, by a metadata tracking system, a processing pipeline for a set of stages that execute the processing pipeline on a machine learning model at a data processing site;
receiving, by the metadata tracking system, a first carbon footprint value associated with iterative executions of a first stage of the processing pipeline, the first stage comprising a first set of task executions within the first stage of the processing pipeline, each of the first set of task executions corresponding to a first set of carbon footprint values;
receiving, by the metadata tracking system, a second carbon footprint value associated with iterative executions of a second stage of the processing pipeline, the second stage comprising a second set of task executions within the second stage of the processing pipeline, each of the second set of task executions corresponding to a second set of carbon footprint values; and
in response to completing execution of the processing pipeline, aggregating the first carbon footprint value, the first set of carbon footprint values, the second carbon footprint value, and the second set of carbon footprint values in determination of a carbon footprint value associated with execution of the processing pipeline on the machine learning model.

2. The computer-implemented method of claim 1, wherein the first carbon footprint value is a cumulative sum of all carbon footprint values in the first set of carbon footprint values.

3. The computer-implemented method of claim 1, wherein the processing pipeline is associated with training the machine learning model, and wherein a data lineage of the processing pipeline comprises steps of data cleaning, feature selection, and model training.

4. The computer-implemented method of claim 1, wherein the processing pipeline is associated with training the machine learning model, and wherein a data lineage of the processing pipeline comprises steps other than data cleaning, feature selection, and model training.

5. The computer-implemented method of claim 1, wherein the processing pipeline comprises an inference stage, post-training adaptation, or deployment of the machine learning model.

6. The computer-implemented method of claim 1, wherein the data processing site comprises a library or agent that is executed concurrently with an application that generates the first stage of the processing pipeline.

7. The computer-implemented method of claim 5, wherein the library or agent is implemented as a callback to the metadata tracking system in transmitting the first carbon footprint value and the second carbon footprint value.

8. A computer-implemented method comprising:
constructing, by a metadata tracking system, a data lineage for generating a first artifact at a data processing site;
receiving, by the metadata tracking system, a first carbon footprint value associated with an iterative execution of the data lineage of the first artifact;
in response to receiving the first carbon footprint value, providing the first artifact to a second task execution in generating a second artifact associated with a second carbon footprint value, the second artifact being an altered version of the first artifact at the data processing site; and
in response to completing execution of the data lineage, aggregating the first carbon footprint value and the second carbon footprint value in determination of a third carbon footprint value associated with generating the first artifact and the second artifact.

9. The computer-implemented method of claim 8, wherein the data processing site is remotely located from the metadata tracking system.

10. The computer-implemented method of claim 8, wherein the metadata tracking system receives the first artifact and the second artifact via an application programming interface (API) implemented with the metadata tracking system that is accessible by the data processing site.

11. The computer-implemented method of claim 8, wherein the data processing site is a first data processing site, and the method further comprises:
receiving a second artifact from a second data processing site, the second data processing site being distinct from the first data processing site.

12. The computer-implemented method of claim 8, wherein the first artifact is a machine learning model before a training process and the second artifact is the machine learning model after the training process.

13. The computer-implemented method of claim 8, wherein the first artifact corresponds with a data file and the second artifact corresponds with the data file that has been moved and changed.

14. A metadata tracking system comprising:
a memory storing instructions; and
a processor communicatively coupled to the memory and configured to execute the instructions to:
generate a first artifact through a data lineage at a data processing site, wherein the first artifact is a machine learning model that is executed at the data processing site of a processing pipeline;
determine a first carbon footprint value for the first artifact;
determine a second carbon footprint value for a second stage of the processing pipeline for generating the machine learning model; and
aggregate the first carbon footprint value and the second carbon footprint value in determination of a third carbon footprint value associated with generating the machine learning model.

15. The metadata tracking system of claim 14, wherein the first carbon footprint value is a cumulative sum of all carbon footprint values in the first set of carbon footprint values.

16. The metadata tracking system of claim 14, wherein the processing pipeline is associated with training the machine learning model, and wherein the data lineage comprise steps of data cleaning, feature selection, and model training.

17. The metadata tracking system of claim 14, wherein the processing pipeline is associated with training the machine learning model, and wherein the data lineage comprise steps other than data cleaning, feature selection, and model training.

18. The metadata tracking system of claim 14, wherein the data processing site comprises a library or agent that is executed concurrently with an application that generates the first artifact at the data processing site.

19. The metadata tracking system of claim 14, wherein the data processing site is remotely located from the metadata tracking system.

20. The metadata tracking system of claim 14, further configured to:
receive the first artifact via an application programming interface (API) that is accessible by the data processing site.
